(19) United States
(12) Patent Application Publication
(10) Pub. No.: US 2007/0162974 A1
(43) Pub. Date: Jul. 12, 2007

(54) Protection System for a Data Processing Device

(75) Inventor: Thomas Speidel, Markgröningen (DE)

Correspondence Address: GUDRUN E. HUCKETT DRAUDT, LONSSTR. 59, WUPPERTAL, 42289, DE

(73) Assignee: ADS-TEC AUTOMATION DATEN- UND SYSTEMTECHNIK GMBH, Leinfelden-Echterdingen (DE)

(21) Appl. No.: 11/688,384

(22) Filed: Mar. 20, 2007

(30) Foreign Application Priority Data
Jul. 9, 2005 (EP) 05 014 938.4

(51) Int. Cl. G06F 11/00; G06F 12/14

(52) U.S. Cl. 726/22

(57) ABSTRACT

A protection system for a data processing device has a scanning device for scanning a data exchange through a physical data connection connecting an internal data processing device to an external data network. A transfer component is connected to the physical data connection for transferring data. A blocking device is provided for blocking the physical data connection when activated. When activated, the blocking device acts in such a way on the transfer component that no data can be transferred through the transfer component.

### BACKGROUND OF THE INVENTION

The invention relates to a protection system for a data processing device that has a physical data connection for connecting an internal data processing device to an external data network, wherein the protection system comprises a scanning device for scanning the data exchanged through the data connection and a blocking device for blocking the physical data connection.

Protection systems for data processing devices, so-called firewalls, are known in general and are used in order to scan data traffic between an internal data processing device and an external data network and in order to prevent unauthorized access from an external data network onto the internal data processing device as well as from the internal data processing device onto the external data network. Blocking of data is realized usually by means of a software program.

In the case of internal data processing devices, it is desirable, for example, for maintenance purposes, to completely block data traffic between the external data network and the internal data processing device.

U.S. 2004/0098621 A1 discloses a firewall system in which a relay is used for separating the data processing device from the data network.

### SUMMARY OF THE INVENTION

It is an object of the present invention to provide a protection system for a data processing device in which a safe separation between an external data network and an internal data processing device can be realized in a simple way.

In accordance with the present invention, this is achieved in that the protection system has a transfer component and in that the blocking device, for blocking the physical data connection, acts on the transfer component in such a way that no data can be transferred through the transfer component.

The blocking device enables thus a secure separation of the internal data processing devices from the external data network independent of software functions like the set of rules of the scanning device. In this way, upon activation of the blocking device, it can be ensured that a separation is indeed effected even when the function of the scanning device, for example, as a result of software malfunction, is no longer ensured. The interruption of the data transfer is realized independent of the sent data. Because the blocking device acts directly on the transfer component no additional components such as switches or the like are required. Because the blocking device makes the transfer component inoperative such that data cannot be transferred through the transfer component, a secure separation of the data processing device from the data network is provided.

Advantageously, the protection system has an external connection, wherein the blocking device is to be activated by means of the external connection for the purpose of blocking the data connection. By means of the external connection, a simple possibility for activation of the blocking device is realized. The external connection enables in this way a secure separation of the internal data processing device from the external data network by means of external control devices. Accordingly, for example, for maintenance purposes of the internal data processing device, a control device can be connected to the external connection and the blocking device can be activated.

It is provided that the blocking device is activatable by the scanning device. For example, when the scanning device detects unauthorized access attempts, the physical data connection can be blocked and in this way the data traffic through the data connection can be interrupted independent of the software functions. Preferably, the blocking device acts on the voltage supply of the transfer component (transceiver). The blocking device can thus interrupt the voltage supply of the transfer component so that no data exchange is possible anymore through the transfer component. It can be provided that the blocking device and the transfer component are connected such that the blocking device can effect a permanent reset state of the transfer component. By means of such permanent reset state, the link is interrupted and no connection is possible anymore so that no data can be transferred anymore through the transfer component and the physical data connection is securely blocked. Other solutions for physically blocking the data connection can be provided also.

In order to enable a simple activation of the blocking device, it is provided that the external connection is a voltage input. By applying a voltage to the external connection, the internal data processing device can be separated from the external data network. Advantageously, the internal data processing device has a detection device for determining the state of the blocking device. In this way, it can be determined whether the blocking device is active, i.e., the connection to the external data network is interrupted or not. This state can be evaluated and the internal data processing device can be operated accordingly.

Another inventive principle resides in that the protection system is provided with a writable event memory; the scanning device writes on the event memory. The arrangement of the event memory in the protection system is advantageous independent of the blocking device of the protection system. Such event memories for protection systems are known but are usually arranged in the internal data processing device, i.e., in servers downstream of the protection system. By providing the event memory in the protection system itself, it is therefore no longer necessary to provide an event memory in the downstream servers.

The event memory is in particular a non volatile memory, in particular, a NVRAM (non volatile random access memory). In order to enable a simple reading of the event memory, it is provided that the event memory has an external output for evaluation of the memory by means of an external reading device. In this way, a simple and easy readout of the event memory is possible even in the case of failure of the data processing device. A further evaluation can then be realized by an appropriate display device even directly on the reading device.

### BRIEF DESCRIPTION OF THE DRAWING

FIG. 1 is a schematic illustration of a protection system with inactive blocking device.

FIG. 2 shows the protection system of FIG. 1 with active blocking device.

FIG. 3 shows the blocking device in a schematic illustration.

### DESCRIPTION OF THE PREFERRED EMBODIMENTS

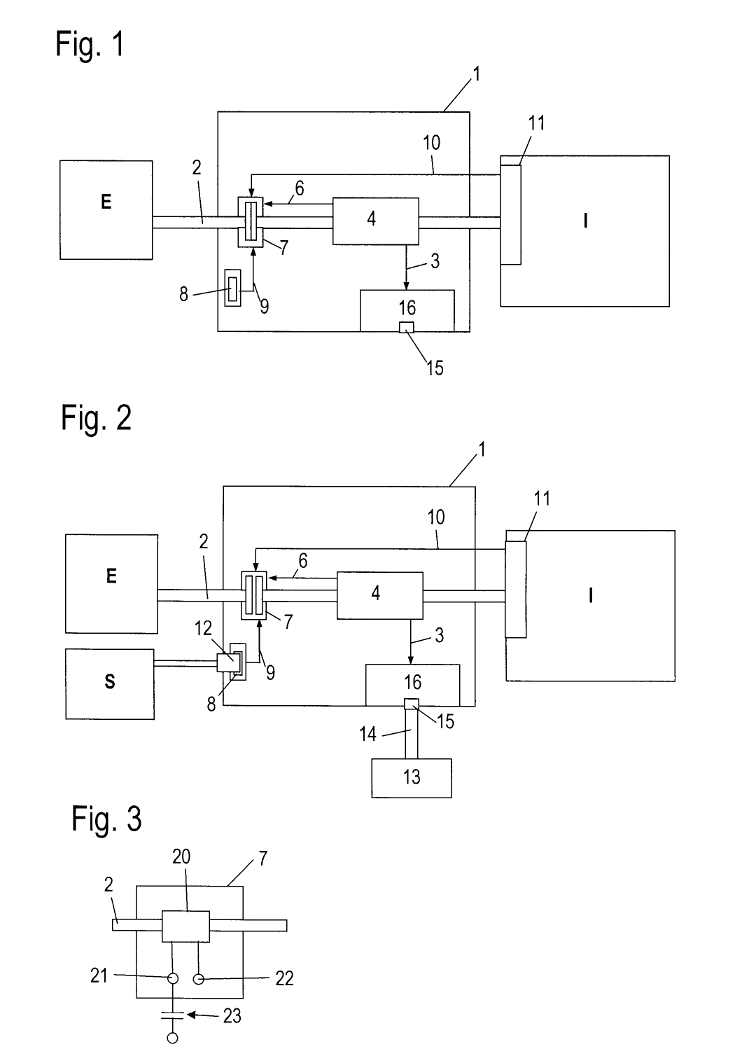

FIG. 1 shows an external data network E that is connected by a data connection 2 to an internal data processing device I. The external data network E can be, for example, the Internet and the internal data processing device can be an intranet or a control system. A protection system 1 is arranged between the external data network E and the internal data processing device I. The protection system 1 has a scanning device 4 that analyzes data exchanged through the data connection 2 and allows data to pass or blocks data flow. The scanning device 4 can be, for example, a packet filter and/or an application gateway. In FIG. 1, the scanning device 4 is embedded by means of two connections to the data connection 2 so that all data that are exchanged through the data connection 2 must pass through the scanning device 4. However, it can also the provided that the scanning device 4 is linked with only one connection to the data connection 2 so that the incoming data as well as the outgoing data will flow through said one connection. The scanning device 4 allows data to pass or enables blocking of data flow based on a set of rules, for example, the filtering rules that are stored in a packet filter. Blocking is realized by the software program. A separation or blocking of the physical data connection 2 at the scanning device 4 is not provided.

For blocking the physical data connection 2, the protection system 1 has a blocking device 7 that is arranged between the scanning device 4 and the external data network E. The blocking device 7 according to arrow 6 can be activated by the scanning device 4 so that the blocking device 7 blocks the physical data connection 2. This state can be detected, as illustrated by arrow 10, by a detection device 11 that is arranged in the internal data processing device I. The detection device 11 is particularly a superordinate network component, for example, a switch or router that is provided upstream of the internal data processing device I. The detection device 11 can evaluate the information in regard to the state of the blocking device 7, i.e., whether the blocking device 7 is activated and the data connection 2 is separated or blocked or whether the blocking device 7 is deactivated and the external data network E is connected to the internal data processing device I, and can control accordingly the data flow in the internal data processing device I. The protection system 1 has an external connector 8 that is connected to the blocking device 7; by means of the connector 8 the blocking device 7 can be activated as indicated by arrow 9. The blocking device 7 can therefore be activated by means of the scanning device 4 as well as by means of the external connector 8.

In known protection systems an event memory, a so-called log file, is provided; it is arranged in the internal data processing device. When the internal data processing device fails, it is not possible to access the event memory. An independent inventive principle according to the present invention provides to arrange the event memory 16 in the protection system 1. The scanning device 4 inputs or writes events into the event memory 16 as illustrated by arrow 3. The event memory 16 is operated in a free-run mode, i.e., as an endless loop. In this connection, as soon as the memory is full, the oldest entries are overwritten. For example, the date and time of the event, the type of the occurring security-relevant event as well as information in regard to contents and sender of the correlated data can be saved in the event memory 16. The event memory 16 preferably contains log entries and statistical data sets. The event memory 16 is in particular a non volatile memory, preferably a NVRAM (non volatile random access memory). The event memory 16 comprises a connector 15 for connecting an external reading device thereto. It can also be advantageous to be able to remove the event memory 16 from the protection system 1 for reading its contents. An event memory 16 can also be used in protection systems that have no blocking device for the separation of the physical data connection.

In FIG. 2, the protection system 1 is illustrated with the blocking device 7 being activated. The control device S is connected to the external connector 8 by means of a plug 12. The external connector 8 is in particular a voltage input. When applying a voltage to the external connector 8 by means of the control device S, the blocking device 7 is activated and the data connection 2 is physically separated so that, independent of the filter rules of the scanning device 4, a data exchange between the external data network E and the internal data processing device I is no longer possible. Preferably, the external connector 8 is a 24 volt direct current connector so that the blocking device 7 separates the data connection 2 when applying a 24 volt current to the external connector 8. A separation of the data connection 2 independent of software functions is therefore possible in a simple and safe way.

For reading the event memory 16, a reading device 13 is connected by means of line 14 to the connector 15. The reading device 13 can read the data in the event memory 16 and can analyze the data. This is possible even when the internal data processing device I experiences failure. In this way, it is possible to determine quickly and simply the reasons for malfunctions, for example, for the failure of the internal data processing device I. For this purpose, no external databases or data memories are required.

The blocking device 7 effects a separation of the physical data connection 2. The effect is comparable to cutting a line. However, the separation is achieved by appropriate switching of components or controllers of the protection system 1. For transfer of the data, the protection system 1 has a transfer component 20, a so-called transceiver, schematically shown in FIG. 3. In FIG. 3, the transfer component 20 is shown as a part of the blocking device 7 but the transfer component 20 can also be embodied separate from the blocking device 7. FIG. 3 is provided only to illustrate the function of the blocking device 7. The blocking device 7 acts for the purpose of blocking the physical data connection 2 on the transfer component 20 in such a way that no data can be transferred through the transfer component 20. The transfer component 20 is made inoperative by the blocking device 7. The transfer component 20 has a voltage supply connector 21 through which the transfer component 20 is supplied with the energy required for data transfer.

For blocking the data connection 2, the blocking device 7 advantageously acts on the voltage supply of the transfer component 20. For this purpose, the blocking device 7 can interrupt the connection of the voltage supply connector 21 to the voltage source 23. By cutting the voltage supply, the blocking device 7 can securely block the transfer through the transfer component 20 so that the physical data connection 2 is separated.

The transfer component 20 has a reset connector 22 where a reset of the component 20 can be triggered. The blocking device 7 can act on the reset connector 22 of the transfer component 20 for blocking the physical data connection 2 and can activate a permanent reset state by a suitable circuit. In the reset state, no data can be transferred through the transfer component 20 so that a safe blocking of the physical data connection 2 is also realized in this way and no data exchange is possible anymore. However, other solutions for the blocking device are conceivable also.

By acting on the voltage supply of the transfer component 20 as well as by generating a permanent reset state of the transfer component 20, the blocking device 7 can act on the transfer component 20 in such a way that no data can be transferred anymore through the transfer component 20 and the physical data connection 2 is blocked.

While specific embodiments of the invention have been shown and described in detail to illustrate the inventive principles, it will be understood that the invention may be embodied otherwise without departing from such principles.

What is claimed is:

1. A protection system for a data processing device, the protection system comprising:
a scanning device for scanning a data exchange through a physical data connection connecting an internal data processing device to an external data network;
a transfer component connected to the physical data connection for transferring data through the physical data connection;
a blocking device for blocking the physical data connection;
wherein the blocking device, for blocking the physical data connection, acts in such a way on the transfer component that no data can be transferred through the transfer component.

2. The protection system according to claim 1, comprising an external connector, wherein the blocking device is activatable by the external connector for blocking the physical data connection.

3. The protection system according to claim 2, wherein the external connector is a voltage input.

4. The protection system according to claim 1, wherein the blocking device is activated by the scanning device.

5. The protection system according to claim 1, wherein the blocking device acts on a voltage supply of the transfer component.

6. The protection system according to claim 1, wherein the blocking device and the transfer component are connected such that the blocking device effects a permanent reset state of the transfer component.

7. The protection system according to claim 1, further comprising a detection device that is arranged in the internal data processing device, wherein the detection device detects a state of the blocking device.

8. The protection system according to claim 1, comprising a writable event memory, wherein the scanning device writes on the writable event memory.

9. The protection system according to claim 8, wherein the writable event memory is a non volatile memory.

10. The protection system according to claim 8, wherein the writable event memory has an external output for evaluation of the writable event memory by an external reading device.
